(19) United States
(12) Patent Application Publication
(10) Pub. No.: US 2002/0187175 A1
(43) Pub. Date: Dec. 12, 2002

(54) Antimicrobial polyurethane films

(76) Inventors: Randy D. Petrea, Spartanburg, SC (US); Robert L. Schuette, Boiling Springs, SC (US); Shirley A. Whiteside, Chesnee, SC (US)

Correspondence Address: Milliken & Company, P.O. Box 1927, Spartanburg, SC, 29304, US

(21) Appl. No.: 09/851,042

(22) Filed: May 8, 2001

(51) Int. Cl. A01N 25/34

(52) U.S. Cl. 424/404

(57) ABSTRACT

Polyurethane films containing certain silver-based antimicrobial formulations therein are provided. Such formulations comprise antimicrobial compounds, such as, preferably silver-containing ion-exchange resins, such as zirconium phosphate, glass, or zeolite compounds. The inventive films exhibit excellent antimicrobial qualities as well as surprisingly good color characteristics. As a result, antimicrobial films are provided which may be transparent or easily colored without the production of undesirable browning and/or yellowing within the target film.

### FIELD OF THE INVENTION

This invention relates to polyurethane films containing certain silver-based antimicrobial formulations therein. Such formulations comprise antimicrobial compounds, such as, preferably silver-containing ion-exchange resins, such as zirconium phosphate, glass, or zeolite compounds. The inventive films exhibit excellent antimicrobial qualities as well as surprisingly good color characteristics. As a result, antimicrobial films are provided which may be transparent or easily colored without the production of undesirable browning and/or yellowing within the target film.

### DISCUSSION OF THE PRIOR ART

All U.S. Patents listed below are herein entirely incorporated by reference.

There has been a great deal of attention in recent years given to the hazards of bacterial contamination from potential everyday exposure. Noteworthy examples of such concerns include the fatal consequences of food poisoning due to certain strains of Eschericia coli being found within undercooked beef in fast food restaurants; Salmonella contamination causing sicknesses from undercooked and unwashed poultry food products; and illnesses and skin infections attributed to Staphylococcus aureus, Klebsiella pneumoniae, yeast, and other unicellular organisms. With such an increased consumer interest in this area, manufacturers have begun introducing antimicrobial agents within various everyday products and articles. For instance, certain brands of polypropylene cutting boards, liquid soaps, etc., all contain antimicrobial compounds. The most popular antimicrobial for such articles is triclosan. Although the incorporation of such a compound within liquid or certain polymeric media has been relatively simple, other substrates, including thin polyurethane films, have proven less accessible. Such compounds are highly desired for films to provide not only antimicrobial benefits, but also mildew and odor control properties. In particular, such films are highly desired for utilization as fabric coatings, food preserving articles [both to prevent introduction of pathogens within the protected food items (i.e., meat, for example) as well as to destroy any bacteria retained within the food package prior to and possibly during storage], and the like.

There thus remains a long-felt need to provide an effective, durable, reliable antimicrobial polyurethane film which provides such long-term effects. Of additional importance is the need to provide such specific films that facilitate, or, at the very least, permit removal from a roll of such film. As is well known and would be well appreciated by one of ordinary skill in this art, such films commonly are produced and then stored on a roll for the consumer to store in a relatively small area. Thus, easy unrolling of such a film is imperative for proper utilization at the consumer stage. Thus, such a desirable film must exhibit suitable anti-tack properties thereby permitting such necessary unrolling without an appreciable amount of adhesion between different rolled layers of the same polyurethane roll itself. In the past, such anti-tack properties have been provided through the incorporation of different compounds, such as talc, magnesium stearate, film surface finishes, and the like. However, such compounds do not provide antimicrobial characteristics as well.

Other antimicrobial films have been disclosed in the past; however, no incorporation of specific silver-based, inorganic antimicrobials (more particularly, though not necessarily, silver-based ion exchange compounds, such as zirconium phosphate salts, as one example) have been disclosed within the prior art. Other organic compounds (triclosan, for example) have been taught for such purposes, however, due to migration concerns and potential health issues with such organic based compounds and compositions, such antimicrobial agents are now avoided, particularly when in potential contact with human skin or items for human consumption.

Discoloration of the films themselves is to be avoided in order to provide a relatively clear storage article. Yellowing or browning are highly discouraged in this sense. The utilization of organic compounds in the past have presented certain potential problems with discoloration such that improvements in this area are highly desired as well.

Thus, there is a need to provide long-lasting antimicrobial polyurethane films that exhibit proper antimicrobial characteristics and likewise do not adhere in any appreciable amount to rolls made thereof (and thus facilitate unrolling for utilization by the end-user), and do not produce unwanted discolorations in any appreciable amount. Unfortunately, to date, no such particular polyurethane films, have been accorded the polyurethane film industry by the pertinent prior art.

### DESCRIPTION OF THE INVENTION

It is thus an object of the invention to provide a polyurethane film comprising silver-based inorganic antimicrobial throughout said film (i.e., the antimicrobial agent is extruded throughout the film and not simply topically applied). It is a further object of the invention to provide a polyurethane film article exhibiting high antimicrobial activity as well as excellent low cohesive and/or adhesive properties, and simultaneously low levels of discoloration from the color of the film component itself. A further object is to provide such excellent low cohesive and/or adhesive properties without the need for high levels of surface coatings contacted with the target film surface, thereby resulting in significant reductions of finishing chemicals used and process steps performed.

Accordingly, this invention encompasses a polyurethane film comprising a silver-based inorganic antimicrobial compound in discrete areas of said film wherein at least some of said antimicrobial compound is present at the surface of said film and, optionally, at least some of said antimicrobial is present within said film. Furthermore, this invention also encompasses a storage article comprising at least layer of said inventive film. Additionally, the invention encompasses a polyurethane film comprising at least one silver-based inorganic antimicrobial compound wherein said film yarn exhibits a cohesive property with either itself or a different film of the same type of below about 150 grams, preferably below about 100 grams, more preferably below about 90 grams, still more preferably below about 75 grams, and most preferably below about 65 grams, as measured by a sliding block friction procedure (thereby exhibiting very low anti-tack properties). Also, this invention encompasses a polyurethane film as defined above, and exhibiting the aforementioned anti-tack characteristics without the presence of an appreciable amount of anti-tack surface agents thereon.

The silver-based inorganic antimicrobial compound of this invention may be any type which imparts the desired log kill rates discussed below to Staphylococcus aureus and Klebsiella pneumoniae. Furthermore, such compounds must be able to be incorporated within the target polyurethane films thereby imparting the aforementioned anti-tack properties as well as, preferably low levels of discoloration therein. Thus, preferred, though non-limiting, silver-based antimicrobials for this invention include silver-based ion-exchange compounds, such as silver-based zirconium phosphates (available from Milliken & Company under the trade designation ALPHASAN®). Although such compounds are preferred, others may be utilized or added in addition to the preferred types, including, again, without limitation, silver ions, elemental silver, silver-based zeolites, silver-based glasses, and any mixtures thereof. Again, most preferably, such a compound is a silver-based ion-exchange compound and particularly does not include any added organic bactericide compounds (thereby not permitting a release of volatile organic compounds into the atmosphere during processing at high temperatures, prevents migration, etc.). Other potentially preferred silver-containing solid inorganic antimicrobials in this invention are silver-substituted zeolites available from Sinanen under the tradename ZEOMIC®, or a silver-substituted glasses available from Ishizuka Glass under the tradename IONPURE®, may be utilized either in addition to or as a substitute for the preferred species. Other possible compounds, again without limitation, are silver-based materials such as MICROFREE®, available from DuPont, as well as JMAC®, available from Johnson Mathey. Generally, such a metal compound is added in an amount of from about 0.01 to 10% by total weight of the particular polyurethane films fibers; preferably from about 0.1 to about 5%; more preferably from about 0.1 to about 2%; and most preferably from about 0.5 to about 2.0%.

The term polyurethane films, as noted above, is intended to cover any standard polyurethane-type thin (from about 10 mils to about 500 mils in thickness) extruded sheets of polyurethane or polyurethane-containing thermoset or thermoplastic. Such films have been utilized for may years in the packaging industries and are generally produced from long-chain, synthetic polymers comprised of at least 85% of a segmented polyurethane, such as those based on polyethers or polyesters.

Such films should be well appreciated by the ordinarily skilled artisan as possessing at least a single-layer configuration. As such, as alluded to above, upon extrusion of the polyurethane with the desired antimicrobial, the target films will contain such antimicrobial compounds throughout their structures. In such an instance, at least a portion of the surface of any inventive film will exhibit some antimicrobial compounds, through production or treatment by various methods, including, without limitation, extrusion of the polyurethane with the antimicrobial therein, or possibly through the contacting of the antimicrobial to the surface (utilizing the tackiness of the film to adhere such compounds thereto) by themselves or with an adhesion agent (including such things as talc). The antimicrobial may also be present within the interior of such a film (by extrusion, for example). Thus, at least some antimicrobial compound must be present within the target inventive film as well. It is to be understood that such a definition does not require every interior portion of the target inventive film to exhibit such antimicrobial activity, only that such antimicrobial compounds are not limited in location to the surface.

The particular antimicrobial compound (or compounds as more than one type may be present) should exhibit an acceptable log kill rate after 24 hours in accordance with the Japanese Industrial Standard Z2801:2000, “Antimicrobial Products—Tests for Antimicrobial Activity and Efficacy”. Such an acceptable level log kill rate is tested for Staphylococcus aureus or Klebsiella pneumoniae of at least 0.1 increase over baseline. Alternatively, an acceptable level will exist if the log kill rate is greater than the log kill rate for non-treated (i.e., no solid inorganic antimicrobial added) films (such as about 0.5 log kill rate increase over control, antimicrobial-free films). Preferably these log kill rate baseline increases are at least 0.3 and 0.3, respectively for S. aureus and K. pneumoniae; more preferably these log kill rates are 0.5 and 0.5, respectively; and most preferably these are 1.0 and 1.0, respectively. Of course, the high end of such log kill rates are much higher than the baseline, on the magnitude of 5.0 (99.999% kill rate). Any rate in between is thus, of course, acceptable as well. However, log kill rates which are negative in number are also acceptable for this invention as long as such measurements are better than that recorded for correlated non-treated films. In such an instance, the antimicrobial material present within the film at least exhibits a hindrance to microbe growth.

As defined herein, the term “sliding block friction procedure” pertains to a test developed to determine the cohesive and adhesive nature of the target film. Basically, a rectangular block having a mass of about 114 g and a surface area on its bottom side of about 56.25 cm² (7.5 cm×6.5 cm) was adhered to a film sample of about the same surface area as the bottom side of the block which, in turn, was contacted with a film sample of the same surface area. The block was then pulled by an attached string present in the middle of one of the sides of the block with the tension required to move the block (attached to the first film sample) from contact with the second film sample. The term “sliding block pull tension” thus is the tension required for the separation of the two film samples during such a procedure. As noted above, it is important to provide a substantially anti-tack film that is easily removed from its roll storage article for utilization by the end-user. A sliding block pull tension of below about 150 grams is required to provide such low cohesive and/or adhesive characteristics for the inventive films with no anti-tack surface coatings or additives present. Lower levels are, of course, highly desired, with below 100 grams preferred, below 90 grams more preferred, below 75 grams still more preferred, and below 65 grams most preferred. Of course, even lower levels are also desired, if possible, without any additives or coating present.

Without intending to be limited to any specific scientific theory, it is believed that such anti-tack benefits are the result of antimicrobial particles present on the surface of the target polyurethane films. Such particles appear to extend outward from the film surface a distance sufficient to prevent repeated and continuous contact between polyurethane components of two separate films (or different portions of the same film). Such a benefit is best noted through the ability to drastically reduce, if not essentially eliminate, the need for the utilization of finish additives from the polyurethane production method. Surprisingly, it has been found that the utilization of certain antimicrobial particles (compounds) within polyurethane films provides not only desirable antimicrobial characteristics, but also excellent anti-tack properties. Thus, the utilization of such antimicrobial as taught within this invention permits a drastic reduction in the amount of surface additives required to provide such anti-tack properties. Furthermore, the utilization of such antimicrobial polyurethane films as now taught permits a reduction in the number of process steps required as well as potential effluent discharge during and after application of such surface finishes. The level of finish additives needed for anti-tack improvements can thus be drastically lowered.

The preferred embodiments of the inventive antimicrobial polyurethane films are discussed in greater detail below. Such inventive films at least comprise some polyurethane constituent (e.g., reaction product of isocyanate and polyol) and are preferably extruded, either through blowing or drawing techniques. The inventive films may also comprise blends of other plastics, including, without limitation, polyethers, polyesters, polyolefins, polyacrylics, and the like

### DESCRIPTION OF THE PREFERRED EMBODIMENTS

Examples of particularly preferred polyurethane films within the scope of the present invention are set forth below.

### Polyurethane Film Production

Thermoplastic polyurethane (TPU) pellets (Pellethane 2103-70A) were obtained from Dow Plastics and mixed with 0.5%, 1.0%, and 2.0% of each antimicrobial additive. A control without any antimicrobial present was also produced with the same polyurethane content. The coated pellets were then dried in a vacuum oven at 105° F. for 24 hours to remove any residual moisture. The pellets were then melt extruded into thin films (about 20 mils thick) through extrusion within a Killion 32:1 KLB-100 Tilt-N-Whirl Model outfitted with a film extrusion die-head with a die temperature setting of 450° F., a melt temperature of about 425° F., and an extrusion screw rate of about 67 rpm, and collected on a roll package.

The specific samples were made produced in accordance with the antimicrobial levels listed below in the Table.

TABLE 1

| Sample # | Antimicrobial Type and Amount (% by weight) |
|---|---|
| 1 | ALPHASAN ® RC-5000 (0.5%) |
| 2 | ALPHASAN ® RC-5000 (1.0%) |
| 3 | ALPHASAN ® RC-5000 (2.0%) |
| 4 | IONPURE ® (0.5%) |
| 5 | IONPURE ® (1.0%) |
| 6 | IONPURE ® (2.0%) |
| 7 | ZEOMIC ® (0.5%) |
| 8 | ZEOMIC ® (1.0%) |
| 9 | ZEOMIC ® (2.0%) |
| 10 (Comparative) | Triclosan (0.5%) |
| 11 (Comparative) | Triclosan (1.0%) |
| 12 (Comparative) | Triclosan (2.0%) |
| Control | |

Some of these samples were then tested for a number of different characteristics, as noted below:

TABLE 2
Sliding Block Pull Tension Measurements

| Example | Tension (in grams) by average |
|---|---|
| 2 | 57.2 g |
| 5 | 63.5 g |
| Control (Comparative) | 238.9 g |

Thus, the inventive films exhibited much better low cohesive and/or adhesive properties than the control.

The Example films were also tested for discoloration (photoreduction) after exposure to typical indoor (fluorescent) light after 1 month of such storage. Of the silver-based microbials, AlphaSan® clearly exhibited the best performance in this instance. Thus, for this purpose AlphaSan®-type antimicrobials are most preferred. The triclosan exhibited excellent colorations as well; however, such an antimicrobial is highly water soluble and thus washes easily from the surface of the target film. Thus, for anti-tack, discoloration, and resiliency within and on the target polyurethane films, the AlphaSan® antimicrobials are, again, most preferred. The discoloration results are as follows, again with a non-antimicrobial control for comparison:

TABLE 3
Discoloration Determinations

| Example | Resultant Color |
|---|---|
| 1 | Off-White |
| 2 | Off-White |
| 3 | Off-White |
| 4 | Light Brown |
| 5 | Copper |
| 6 | Bronze |
| 7 | Copper |
| 8 | Copper |
| 9 | Light Copper |
| 10 (Comparative) | Off-White (greenish tint) |
| 11 (Comparative) | Off-White (greenish tint) |
| 12 (Comparative) | Off-White (greenish tint) |
| Control (Comparative) | Clear |

Thus, the inventive sample films 1-3 were the best for this test, along with comparatives 10-12 and the control.

These Examples were also tested for antimicrobial activity in accordance with Japanese Industrial Standard Z2801:2000, “Antimicrobial Products—Tests for Antimicrobial Activity and Efficacy”, herein entirely incorporated by reference, for measuring log kill rates for Klebsiella pneumoniae after 24 hours exposure at room temperature. The follows, again with comparative triclosan-containing films and a non-antimicrobial control polyurethane film (the maximum kill rate measurable is 4.38 for these sample due to the amount of bacteria applied to the sample surfaces; thus anything above 4.38 kills at an extraordinarily high rate):

TABLE 4
Antimicrobial Results

| Example | Log Kill Rate |
|---|---|
| 1 | >4.38 |
| 2 | >4.38 |
| 3 | >4.38 |
| 4 | >4.38 |
| 5 | >4.38 |
| 6 | >4.38 |
| 7 | >4.38 |
| 8 | >4.38 |
| 9 | 4.35 |
| 10 (Comparative) | 1.05 |
| 11 (Comparative) | 0.90 |
| 12 (Comparative) | 0.78 |
| Control (Comparative) | 0.43 |

Thus, the inventive films (1-9) all exhibited excellent antimicrobial efficacy. The Comparatives were much lower as was the Control. Also, the inventive polyurethane films exhibit excellent anti-tack characteristics as well as acceptable antimicrobial properties. Furthermore, the preferred ion-exchange antimicrobial compound exhibited excellent colorations ( and low degrees of discoloration) within the target films as well.

There are, of course, many alternative embodiments and modifications of the present invention which are intended to be included within the spirit and scope of the following claims.

What we claim is:

1. A polyurethane film comprising a silver-based inorganic antimicrobial compound in discrete areas of said film wherein at least some of said antimicrobial compound is present at the surface of said film and, optionally, at least some of said antimicrobial is present within the interior of said film.

2. The polyurethane film of claim 1 wherein said antimicrobial is present within the interior of said film.

3. The polyurethane film of claim 2 wherein said antimicrobial compound is selected from the group consisting of elemental silver, silver-based ion exchange compounds, silver-based zeolites, silver-based glasses, and any mixtures thereof.

4. The polyurethane film of claim 3 wherein said antimicrobial compound is selected from the group consisting of at least one silver-based ion-exchange compound.

5. The polyurethane film of claim 4 wherein said formulation does not include any added organic bactericide compound.

6. The polyurethane film of claim 4 wherein said antimicrobial compound is at least one silver-based antimicrobial zirconium phosphate compound.

7. The polyurethane film of claim 1 wherein said film exhibits a cohesive property with either itself or a different film of the same type as measured by a sliding block pull tension of below about 150 grams as measured by a sliding block friction procedure.

8. The polyurethane film of claim 7 wherein said film exhibits a cohesive property with either itself or a different film of the same type as measured by a sliding block pull tension of below about 100 grams as measured by a sliding block friction procedure.

9. The polyurethane film of claim 8 wherein said film exhibits a cohesive property with either itself or a different film of the same type as measured by a sliding block pull tension of below about 90 grams as measured by a sliding block friction procedure.

10. The polyurethane film of claim 9 wherein said film exhibits a cohesive property with either itself or a different film of the same type as measured by a sliding block pull tension of below about 75 grams as measured by a sliding block friction procedure.

11. The polyurethane film of claim 10 wherein said film exhibits a cohesive property with either itself or a different film of the same type as measured by a sliding block pull tension of below about 65 grams as measured by a sliding block friction procedure.

12. The polyurethane film of claim 2 wherein said film exhibits a cohesive property with either itself or a different film of the same type as measured by a sliding block pull tension of below about 150 grams as measured by a sliding block friction procedure.

13. The polyurethane film of claim 12 wherein said film exhibits a cohesive property with either itself or a different film of the same type as measured by a sliding block pull tension of below about 100 grams as measured by a sliding block friction procedure.

14. The polyurethane film of claim 13 wherein said film exhibits a cohesive property with either itself or a different film of the same type as measured by a sliding block pull tension of below about 90 grams as measured by a sliding block friction procedure.

15. The polyurethane film of claim 14 wherein said film exhibits a cohesive property with either itself or a different film of the same type as measured by a sliding block pull tension of below about 75 grams as measured by a sliding block friction procedure.

16. The polyurethane film of claim 15 wherein said film exhibits a cohesive property with either itself or a different film of the same type as measured by a sliding block pull tension of below about 65 grams as measured by a sliding block friction procedure.
